(19) United States
(12) Patent Application Publication
(10) Pub. No.: US 2009/0137233 A1
(43) Pub. Date: May 28, 2009

(54) Method of and System for Facilitating Telecommunications Contact

(76) Inventors: Robert Hinds, Queensland (AU); Eric Carl Retra, Queensland (AU)

Correspondence Address: ABELMAN, FRAYNE & SCHWAB, 666 THIRD AVENUE, 10TH FLOOR, NEW YORK, NY, 10017, US

(21) Appl. No.: 12/087,096

(22) PCT Filed: Dec. 20, 2006
(86) PCT No.: PCT/AU2006/001944

§ 371 Date: Oct. 7, 2008

(30) Foreign Application Priority Data
Dec. 23, 2005 (AU) 2005907269

(51) Int. Cl. H04W 4/12; G06F 17/30

(52) U.S. Cl. 455/414.3; 707/5; 707/E17.014

(57) ABSTRACT

A system for facilitating telecommunications contact including: a telecommunications network; a product information system having: an information file listing a set of predetermined code words relevant to one or more goods or services provided by one or more goods or service providers with a corresponding set of predetermined codes relevant the or each goods or services provider; a query module interactable with the information file and operable for seeking a code word from said set of code words to retrieve the corresponding predetermined code; and a connection module associated with the telecommunications network and operable for interconnecting a goods or service provider selected according to a code word input into the query module.

### FIELD OF INVENTION

THIS INVENTION relates to a method of, and system for, facilitating telecommunications contact. The invention has particular application to facilitating telephone contact for voice communications between two parties, and in this specification, reference will be made to such application. However, it will be appreciated that the invention is not limited to this field of use.

### BACKGROUND ART

In this specification, the term SMS is normally used to refer to Small Messaging System and/or Short Message Service (as it is referred to by Sprint) and is to be taken to have this meaning unless the context indicates otherwise.

Internet based telecommunications contact has been provided where a supplier provides a link on a website or the like which enables some person associated with the website owner to make contact by telephone to the party accessing the website and is sometimes known as “Web Based Click Calling”. Web Based Click Calling is usually provided as a service independently from the website editing, hosting and/or monitoring. Even though such a facility is very useful for website owners, it is limited in its application to persons accessing the Internet in general and the relevant website in particular.

A call-connection system is disclosed in European Patent No. 1,195,975 in which a user having access to an SMS-capable telephone is provided with a telephone connection upon transmission of an SMS to a message decoder, the SMS indicating a service requested by the user. In order to facilitate the call connection, a database having information correlating the service provider, who becomes a calling party with the service that the user has requested is accessed before the call connection can be made. U.S. patent application Ser. No. 10/058,424 (published as US 2003/0144895) discloses a similar system for providing a personal advisory service, still limited to the use of a database, but with extra filters and services provided to facilitate charges to the user and service providers subscribing to the call-connection service, and a set of answers to a query sent to the call-connection service.

Access to specific information stored on or in connection with a computer is typically limited to queries formulated according to a query language specific for the database type and a vocabulary within that language specific to the database being queried. However, the Internet has expanded in its content and capability to emerge as a vast resource of information whereby new applications using already stored information normally requires a mirror or the like of a database to be provided to access information for a new application.

The present invention aims to provide a method of, and system for, facilitating telecommunications contact which addresses the aforementioned limitations and/or issues. Other aims and advantages of the invention may become apparent from the following description.

### DISCLOSURE OF THE INVENTION

With the foregoing in view, the present invention in one aspect resides broadly in a system for facilitating telecommunications contact including:

a telecommunications network;

a product information system having:
an information file listing a set of predetermined code words relevant to one or more goods or services provided by one or more goods or service providers with a corresponding set of predetermined codes relevant the or each goods or services provider;
a query module interactable with said information file and operable for seeking a code word from said set of code words to retrieve the corresponding predetermined code;
a connection module associated with the telecommunications network and operable for interconnecting a goods or service provider selected according to a code word input into said query module.

The query module may include or be in the form of an SMS gateway operable to receive and filter one or more SMS's from one or more senders, the filtering of the SMS's being according to the set of predetermined code words. A preferred form of information file is a file formulated in hypertext mark-up language such as may be displayed by a web browser program, even though the user would not access the information file itself on the Internet. In such form, the information file may be referred to as the master web page.

In another aspect, the present invention resides broadly in a system for facilitating telecommunications contact including:

an SMS gateway operable to receive and filter one or more SMS's from one or more senders, the filtering of the SMS's being according to a set of predetermined code words;

a connection module associated with said SMS gateway and interactable with a query module, said query module being operable to identify a goods or service provider from an information file listing the set of predetermined code words with a corresponding set of predetermined codes relevant the or each goods or services provider for telecommunications connection of the identified goods or service provider with the sender of an SMS.

Preferably, telecommunications network takes the form of a telephone network, such as a public switched telephone network (PSTN). The information file listing may obtain information from a query source. The query source may be a module operable to generate an information file listing from a database. It will be appreciated that it is not essential that the PSTN be limited to a public switched telephone network as such, and is to be taken to include private telephone and/or telecommunications networks. Preferably, the SMS gateway is accessible by way of the telecommunications network, such as, for example, the same telecommunications network to which the connection module is operably connectable. Preferably, the query module is operable to receive voice, short message system (SMS) and/or email queries. In such form, the query module preferably incorporates a code input module into which the code may be entered, and connected thereto, a query interpretation module, an interactive voice response module, an SMS and email gateway and a response output module. It is also preferred that the code input module and response output module be integrated whereby queries to the information file listing and the answers retrieved therefrom are accommodated on the same device.

In another aspect, the present invention resides broadly in a method of facilitating telecommunications contact including:

providing a telecommunications network and a product information system as hereinbefore described;

inputting a spoken or typed code selected from the set of predetermined codes from a query source into the query module;

converting the spoken or typed code to an SMS query;

looking up the identity of a responding party in the information file relevant to the code; and

connecting the responding party to the query source.

In another aspect, the present invention resides broadly in a method of facilitating telecommunications contact including:

providing a product information system incorporating an information file listing a set of predetermined code words relevant to one or more goods or services provided by one or more goods or service providers with a corresponding set of predetermined codes relevant the or each goods or services provider;

inputting a spoken or typed code selected from a predetermined set of code words into the product information system;

searching for a responding party from the goods or service providers listed in the information file according to the code spoken or typed; and

connecting the responding party to the query source.

Preferably, the inputting of the code by the query source is by way of a connection code to the SMS gateway. Preferably, the product information system includes one or more data tables, a query module, a query interpretation module, a query input module and a connection module as hereinbefore described, the modules being substantially constituted in software operable on a general purpose digital computer.

Preferably, a user intending to be a query source or querying party accesses the query input module by way of a telecommunications network, such as, for example, the public switched telephone network. Preferably, the user inputs a voice query, SMS query, email query or such like, the query input module being operable to receive such queries, the query constituting or including a code word selected from a predetermined set of code words, the code word being sent by way of a connection code such as a telephone number. The query is then preferably processed by the query interpretation module preferably using, for example, an interactive voice response module or an SMS and email gateway to the information file query module, the selection of the module or gateway being determined by an initial assessment of the nature of the query. More preferably, the connection between the query source and the information file is through a product information system by way of the internet, preferably using a gateway-to-gateway connection. The information file may be generated from a database, such as, for example, a telephone number listing as a “Yellow Pages” service or such like. It is not necessary to mirror a database for incorporation into the system of the present invention since the information file is “data mined” or scanned for the relevant code word. The information file is generateable from a database using the query structure and/or rules for generating a database report. In such form, the system includes a module for generating the master web page described above. The master web page is scanned for the relevant code words in operating the system in accordance with the present invention, thereby bypassing any database from which the information in the information file is sourced. Although databases have the advantage of being readily accessible with the right software, the system of the present invention is independent of databases, thereby obviating the necessity to provide specific accessibility to such databases or to mirror and reconfigure databases to provide access to the data therein for the purposes of facilitating telecommunications contact. The information file is distinguished itself from a database inasmuch as it is not indexed, does not require database structure as in fields and records, and the information therein is obtained by conducting a search, scan or data mining of the information in the information file.

The code may be a number or word, more preferably a word associated with the goods or service provider, whereby the goods or service provider is put into telecommunications contact with the user. In a preferred form, the predetermined code identifies by readily recognisable indicia the goods or services of the goods or service provider, or possibly the goods or service provider by name. For example, where the product is a motor vehicle, the code may be “cars”. Where the product is a real estate property, the code may be “real estate”. Where the connection code is the name of a supplier, the word may be, for example, “Belinda's Florist” for a business trading under the name “Belinda's Florist”. Access to the system is preferably by telephone, the telephone number being provided in conjunction with advertising, notification of other means of indicating to potential users the goods or services provided by the supplier. The telephone number provides operative connection to the information file.

### BRIEF DESCRIPTION OF THE DRAWINGS

In order that the invention may be more readily understood and put into practical effect, reference will now be made to the accompanying drawings which illustrate a system of the prior art and other systems in exemplary form of a preferred embodiment of the invention, together with the usage of such systems and wherein:

FIG. 1 is a diagrammatic representation illustrative of a telecommunications connection system for facilitating telecommunications contact according to the prior art;

FIG. 2 is a diagrammatic representation illustrative of a first embodiment of a system for facilitating telecommunications contact according to the invention;

FIG. 3 is a diagrammatic representation illustrative of a second embodiment of another system for facilitating telecommunications contact according to the invention; and

FIG. 4 is a diagrammatic representation illustrative of a preferred embodiment of another system for facilitating telecommunications contact according to the invention.

### DETAILED DESCRIPTION OF THE DRAWINGS

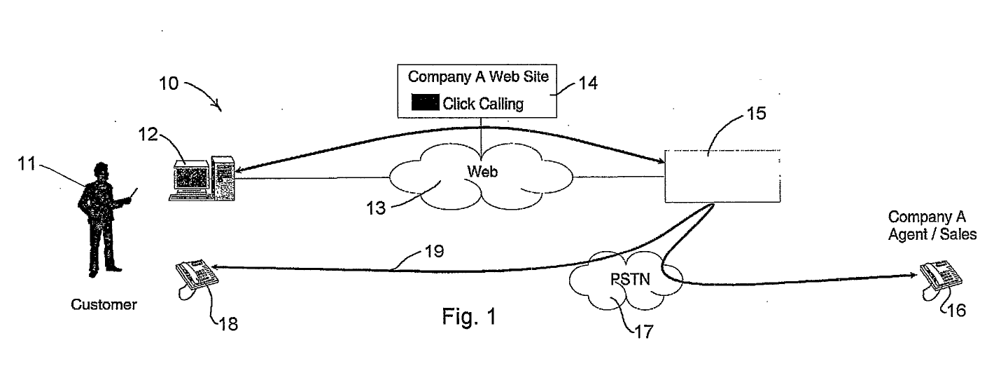

The prior art system 10 for facilitating shown in FIG. 1 provides for a user 11 using a computer 12 to access a webpage of a website 14 on the internet 13. A hyperlink on the webpage facilitates contact with a connection provider 15, whereupon the connection provider 15 calls the goods or services provider on their telephone at 16. Once the goods or service provider answers the telephone, a call is made to the user on their telephone at 18 via the PSTN 17 and land line 19 thereby facilitating the telecommunications contact according to the prior art.

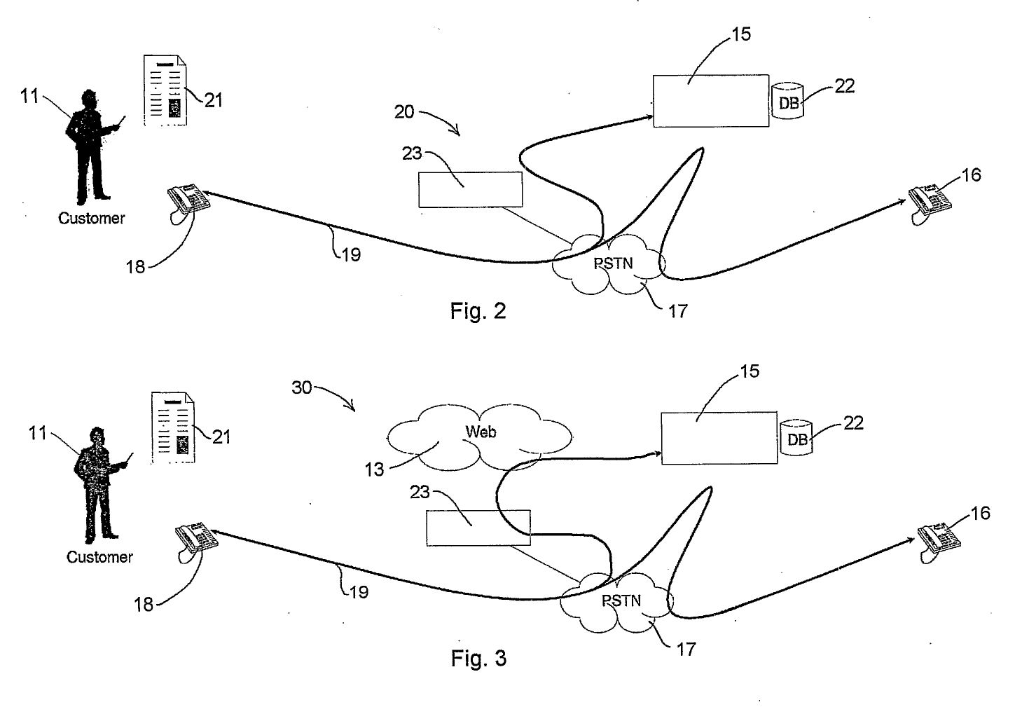

In the case of the first system for facilitating telecommunications contact 20 in FIG. 2, the user observes the identification code and communications code on an advertising bill 21 or the like, and uses the communications code (the telephone number) to call and enter the identification code on their telephone 18 via the land line 19 and the PSTN to the connection provider 15 having access to a data file 22 of information linking the set of predetermined codes to the identities of goods and service providers. Once the query is processed by the data file, a call is made to the user on their telephone at 18 via the PSTN 17 and land line 19 thereby facilitating the telecommunications contact according to the present invention. The connection between the querying party and the database may be by way of a product information system 23.

In the case of the second system for facilitating telecommunications contact 30 in FIG. 3, elements shown therein having the same reference numerals as those of FIG. 2 have the substantially same function. However, telephone call or SMS from the telephone 18 proceeds to the data file 22 by way of a product information system 23 and the internet 13, the latter connection being by way of a gateway-to-gateway connection. Once the query is processed by the data file, a call is made to the user on their telephone at 18 via the PSTN 17 and land line 19 thereby facilitating the telecommunications contact according to the present invention.

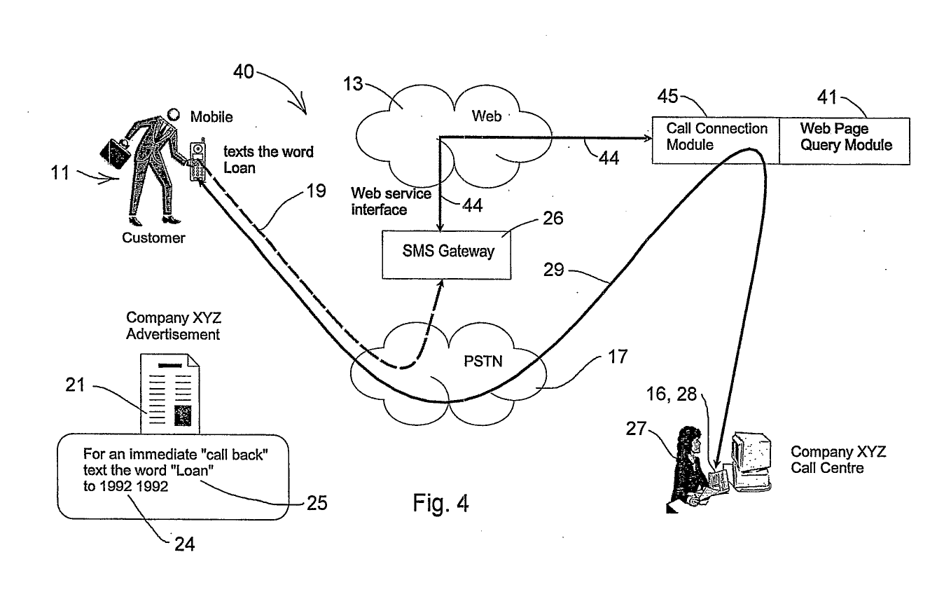

In the case of the preferred system for facilitating telecommunications contact 40 in FIG. 4, elements shown therein having the same reference numerals as those of FIGS. 2 and 3 have the substantially same function. The user 11 observes an identification code 25 and communications code 24. In order to make use of the service according to the invention, the user would then test the identification code, the word “Loan” to the communications code, being the telephone number “19921992”, the communication being represented diagrammatically at 19, a landline or wireless connection through the PSTN 17 to an SMS gateway 26. The SMS gateway may include a translation module for translating common misspellings of the code word, including, for example, capitalisation or non-capitalisation and the like. The SMS gateway converts the SMS to a web compatible communications protocol such as hypertext transfer protocol (http) and thereby links to a call connection module 45 by way of a web link 44 through the world-wide web 13 of the internet. The call connection module makes use of a web page query module 41 which looks up an information file listing an information file listing a set of predetermined code words relevant to one or more goods or services provided by one or more goods or service providers. The predetermined code words correspond with set of predetermined codes relevant the goods or services providers 27. The relevant goods or service provider selected by the query module is connected by their computer 28 or telephone 16 to the user, thereby facilitating telecommunications contact in accordance with the present invention through a landline or wireless connection 29.

In the example described, the information file is generated by a web browser having a search engine to produce search results in the form of a web page in hypertext mark-up language or the like. The query module crawls, scans or otherwise searches through the web page for the information required to make the call connection. Accordingly, the query module includes program code to effect the search or “scrape” of data relevant to the making of the call connection, but it will be appreciated that persons of ordinary skill in the art could produce such program code using well known programming techniques and/or software tools.

Once the connection provider connects the querying and responding parties, all connections other than the connection through the PSTN are terminated. In use, the querying party wanting, for example, a taxicab service can send an SMS message consisting of the word “taxi” to a particular telephone number. Within a short time thereafter, the querying party receives a call by which the caller indicates that they will shortly be put through to the service requested, whereupon the querying party then is placed in telephone contact with the taxicab service. It will be seen that the responding party would be required to provide a level of telephone service that enables the querying party to talk to a responding party substantially without delay. Additionally, it can be seen that if a particular telephone number is used for a wide range of goods and services for which telecommunications contact can be facilitated according to the present invention, that number may become well known, and the generic terms for sourcing goods and services may become valuable in their own right.

In a particular example, goods or service providers register the code for their services for a registration fee and a renewal fee, the proper checks and balances being provided according to a policy developed by the operators of the system. It can be seen that the method and system of the present invention facilitates telecommunications contact irrespective of whether the user is on the internet or not. It will be appreciated also that this system may be used in conjunction with that described in our co-pending International Patent Application No. PCT/AU2005/000540. However, while there are some similarities, in International Patent Application, the system described is for specific items on the market, and provides for the downloading of information relevant to such items, whereas the system is more general, and permits a supplier of goods or services generally (albeit in a particular market segment) to make telephone contact with prospective customers who have made use of the system to be put into contact with a sales person, consultant or advisor.

Although the invention has been described with reference to one or more specific examples, it will be appreciated by those skilled in the art that the invention may be embodied in other forms within the broad scope and ambit of the invention as herein set forth.

1. A system for facilitating telecommunications contact including: a telecommunications network; a product information system having: an information file listing a set of predetermined code words relevant to one or more goods or services provided by one or more goods or service providers with a corresponding set of predetermined codes relevant the or each goods or services provider; a query module interactable with said information file and operable for seeking a code word from said set of code words to retrieve the corresponding predetermined code; a connection module associated with the telecommunications network and operable for interconnecting a goods or service provider selected according to a code word input into said query module.

2. A system for facilitating telecommunications contact according to claim 1, wherein the query module includes an SMS gateway operable to receive and filter one or more SMS's from one or more senders, the filtering of the SMS's being according to the set of predetermined code words.

3. A system for facilitating telecommunications contact according to claim 2, wherein the information file is formulated in hypertext mark-up language such as may be displayed by a web browser program.

4. A system for facilitating telecommunications contact including: an SMS gateway operable to receive and filter one or more SMS's from one or more senders, the filtering of the SMS's being according to a set of predetermined code words; a connection module associated with said SMS gateway and interactable with a query module, said query module being operable to identify a goods or service provider from an information file listing the set of predetermined code words with a corresponding set of predetermined codes relevant the or each goods or services provider for telecommunications connection of the identified goods or service provider with the sender of an SMS.

5. A system for facilitating telecommunications contact according to claim 4, wherein the information file listing includes information obtained from a query source operable to generate said information file listing from a database.

6. A system for facilitating telecommunication s contact according to claim 5, wherein the query module is operable to receive voice, short message system (SMS) and/or email queries, the query module incorporating a code input module into which the code may be entered, and connected thereto, a query interpretation module, an interactive voice response module, an SMS and email gateway and a response output module. It is also preferred that the code input module and response output module be integrated whereby queries to the information file listing and the answers retrieved therefrom are accommodated on the same device.

7. A method of facilitating telecommunications contact including: providing a telecommunications network and a product information system as hereinbefore described; inputting a spoken or typed code selected from the set of predetermined codes from a query source into the query module; converting the spoken or typed code to an SMS query; looking up the identity of a responding party in the information file relevant to the code; and connecting the responding party to the query source.

8. A method of facilitating telecommunications contact including: providing a product information system incorporating an information file listing a set of predetermined code words relevant to one or more goods or services provided by one or more goods or service providers with a corresponding set of predetermined codes relevant the or each goods or services provider; inputting a spoken or typed code selected from a predetermined set of code words into the product information system; searching for a responding party from the goods or service providers listed in the information file according to the code spoken or typed; and connecting the responding party to the query source.

9. A method according to claim 8, wherein the inputting of the code by the query source is by way of a connection code to the SMS gateway.

10. A system for facilitating telecommunications contact according to claim 1, wherein the information file listing includes information obtained from a query source operable to generate said information file listing from a database.
